(19) United States
(12) Patent Application Publication
(10) Pub. No.: US 2016/0167791 A1
(43) Pub. Date: Jun. 16, 2016

(54) PLATED POLYMER AVIATION COMPONENTS

(71) Applicant: UNITED TECHNOLOGIES CORPORATION, Farmington, CT (US)

(72) Inventors: James T. Roach, Vernon, CT (US); Grant Cook, Spring, TX (US); Shari L. Bugaj, Haddam, CT (US); Majidullah Dehlavi, Manchester, CT (US); Kevin W. Schlichting, South Glastonbury, CT (US); Joseph Parkos, East Haddam, CT (US); Glenn Levasseur, Colchester, CT (US)

(21) Appl. No.: 14/903,566

(22) PCT Filed: Jul. 9, 2014
(86) PCT No.: PCT/US2014/045920

§ 371 Date: Jan. 7, 2016

Related U.S. Application Data
(60) Provisional application No. 61/844,127, filed on Jul. 9, 2013.

(51) Int. Cl. B64D 15/00; H05B 3/06; C23C 18/16; C25D 5/56; C25D 7/00

(52) U.S. Cl. CPC B64D 15/00; C25D 5/56; C25D 7/00; C23C 18/1651; H05B 3/06

(57) ABSTRACT

Aviation components comprising a polymeric substrate having an outer surface wherein a metal is plated onto the outer surface to form a plated layer are disclosed. A method to make aviation components comprising a polymeric substrate having an outer surface and where a metal is plated onto the outer surface is disclosed. An over-plated heating element for shedding ice from an aircraft component having a polymeric substrate with a pocket to receive a heating element, a metal deposited onto the substrate, a heating element positioned within the pocket and a covering layer deposited onto the heating element and the plated layer is disclosed.

### CROSS-REFERENCE TO RELATED APPLICATIONS

This application claims priority under 35 U.S.C. §119(e) to U.S. Provisional Patent Application Ser. No. 61/844,127 filed on Jul. 9, 2013.

### FIELD OF THE DISCLOSURE

The present disclosure generally relates to metal-plated polymeric components for aircraft having improved physical and mechanical properties. More specifically, this disclosure relates to metal-plated polymeric components having improved properties such as increased interfacial bond strengths, increased durability, improved heat resistance, and improved wear and erosion resistance and how these structures can be implemented in aircraft components.

### BACKGROUND

Metal-plated polymeric structures consist of a polymeric substrate coated with a metallic plating. These materials are lightweight and, by virtue of the metallic plating, exhibit markedly enhanced structural strengths over the strength of the polymeric substrate alone. These properties have made them attractive materials for component fabrication in many industries such as aerospace, automotive, and military equipment industries, where high-strength and lightweight materials are desired. For example, metal-plated polymeric structures continue to be explored for use in gas turbine engine applications to reduce the overall weight of the engine and improve engine efficiency and fuel savings. However, the strength and performance characteristics of metal-plated polymeric structures may be dependent upon the integrity of the interfacial bond between the metallic plating and the underlying polymeric substrate. Even though the surface of the polymeric substrate may be etched or abraded to promote the adhesion of metals to the polymeric surface and to increase the surface area of contact between the metallic plating layer and the polymeric substrate, the interfacial bond strength between the metallic plating and the polymeric substrate may be the structurally weak point of metal-plated polymeric materials. As such, the metallic plating layers may risk becoming disengaged from polymeric substrate surfaces and this could lead to part failure in some circumstances.

The interfacial bond strength between the metallic plating and the underlying polymeric substrate may be compromised upon exposure to high temperatures, such as those experienced during some high temperature engine operations. If metal-plated polymers are exposed to temperatures over a critical temperature or a sufficient amount of thermal fatigue (thermal cycling or applied loads at elevated temperatures) during operation, the interfacial bond between the metallic plating and the polymeric substrate may be at least partially degraded, which may lead to structural break-down of the component and possible in-service failure. In addition, as polymeric materials have a tendency to release gas (outgas) when exposed to high temperatures, such outgassing may be blocked by the metallic plating layer in metal-plated polymeric materials. Blocking of polymer outgassing may cause the polymeric substrate to expand, resulting in defects in the metallic plating layer and the structure of the part as a whole. Unfortunately, brief or minor exposures of metal-plated polymer components to structurally-compromising temperatures may go largely undetected in many circumstances, as the weakening of the bond between the metal-plating and the underlying polymeric substrate may be difficult to detect. To provide performance characteristics necessary for the safe use of metal-plated polymeric materials in gas turbine engines and other applications, enhancements are needed to improve the interfacial bond strengths and the high temperature stability of metal-plated polymeric components.

In addition, certain surfaces of metal-plated polymers may be damaged by wear or erosion. Wear-critical surfaces may include surfaces involved in interference fits, mating surfaces, or other surfaces which are installed and uninstalled frequently or surfaces exposed to a fluid (gas or liquid) flow. In addition, certain surfaces may be more susceptible than others to wear by impact and foreign-object damage. Erosion-susceptible surfaces may include edges, corner radii, or curved surfaces which may experience enhanced impact with particles in a fluid during operation. Current plating methods used in the fabrication of metal-plated polymeric components may result in a near uniform thickness of the metallic plating layer across the part, such that all surfaces of the metallic plating layer may have approximately the same resistance against wear or erosion. Accordingly, enhancements are needed to selectively impart enhanced protection to wear-critical and erosion-susceptible regions of metal-plated polymeric materials to further improve the performance characteristics of these structures.

### SUMMARY OF THE DISCLOSURE

In accordance with an aspect of the present disclosure, a component for an aircraft is disclosed. The component may comprise a polymeric substrate having an outer surface and have a first metal deposited on the outer surface creating a plated layer.

In a refinement, the polymeric substrate may be formed into an unmanned aerial vehicle, a wing, a control surface, an empennage, a foreplane, a fuselage, aircraft landing gear, an aircraft instrumentation panel, an aircraft seat or an aircraft pontoon.

In another refinement, the formed into one of may be performed with a process selected from the group consisting of injection-molding, compression-molding, blow-molding, liquid bed additive manufacturing, powder bed additive manufacturing, deposition process additive manufacturing, autoclave composite-layup, compression composite layup, liquid molding composite layup and combinations thereof.

In another refinement, the polymeric substrate may be a thermoplastic material that may be selected from the group consisting of polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof

In another refinement, the polymeric substrate may be a thermoset material that may be selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, thermoset silicones and combinations thereof.

In another refinement, the polymeric substrate may be strengthened with reinforcing materials selected from the group consisting of carbon, metal, glass and combinations thereof.

In another refinement, the plated layer may have a windward surface and a leeward surface and may have a thicker plated layer on the windward surface than the leeward surface.

In another refinement, an additional metal may be disposed onto the first metal.

In another refinement, a mounting feature may be bonded onto the polymeric substrate and may be selected from the group consisting of flanges, bosses and combinations thereof.

In another refinement, a mounting feature may be bonded onto the plating layer and may be selected from the group consisting of flanges, bosses and combinations thereof.

In accordance with another aspect of the present disclosure, a method for fabricating a component for an aircraft is disclosed. The method may include the steps of forming a polymeric substrate into a desired shape having an outer surface followed by plating a first metal onto the outer surface to form a plated layer.

In a refinement, the desired shape may be selected from the group consisting of an unmanned aerial vehicle, a wing, a control surface, an empennage, a foreplane, a fuselage, aircraft landing gear, an aircraft instrumentation panel, an aircraft seat and an aircraft pontoon.

In another refinement, the forming a polymeric substrate into a desired shape may be performed with a process selected from the group consisting of injection-molding, compression-molding, blow-molding, liquid bed additive manufacturing, powder bed additive manufacturing, deposition process additive manufacturing, autoclave composite-layup, compression composite layup, liquid molding composite layup and combinations thereof.

In another refinement, the polymeric substrate may be a thermoplastic material and may be selected from the group consisting of polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof.

In another refinement, the polymeric substrate may be a thermoset material and may be selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

In another refinement, the polymeric substrate may be strengthened with a reinforcing material selected from the group consisting of carbon, metal, glass and combinations thereof.

In another refinement, the plated layer may have a windward surface and a leeward surface and the plating may create a thicker plated layer on the windward surface than the leeward surface.

In another refinement, a mounting feature may be bonded onto the polymeric substrate before plating and the mounting feature may be selected from the group consisting of flanges, bosses and combinations thereof.

In another refinement, a mounting feature may be bonded onto the plated layer and the mounting feature may be selected from the group consisting of flanges, bosses and combinations thereof.

In accordance with another aspect of the present disclosure, an over-plated heating device for shedding ice from an aircraft is disclosed. The heating device may comprise a polymeric substrate having a pocket to receive a heating element and having an outer surface. A first metal may be deposited onto the outer surface to create a plated layer. The heating element may be positioned in the pocket of the polymeric substrate and an insulating layer may be positioned between the polymeric substrate and the heating element. The device may further include a covering layer deposited onto the heating element and the plated layer.

### BRIEF DESCRIPTION OF THE DRAWINGS

FIG. 1 is a perspective view of an unmanned aerial vehicle constructed in accordance with an embodiment of the present disclosure.

FIG. 2 is a cross-sectional view of the fuselage of an unmanned aerial vehicle taken along the line 2-2 in FIG. 1.

FIG. 3 is a cross-sectional view of a plated polymer constructed in accordance with an embodiment of the present disclosure.

FIG. 4 is a perspective view of an aircraft, specifically a passenger plane, constructed in accordance with an embodiment of the present disclosure.

FIG. 5 is a cross-sectional view of a wing taken along the line 5-5 in FIG. 4.

FIG. 6 is a perspective view of a control surface constructed in accordance with an embodiment of the present disclosure.

FIG. 7 is a cross-sectional view of a control surface taken along the line 7-7 in FIG. 6.

FIG. 8 is a perspective view of an empennage constructed in accordance with an embodiment of the present disclosure.

FIG. 9 is a cross-sectional view of an empennage taken along the line 9-9 in FIG. 8.

FIG. 10 is a plan view of an aircraft, more specifically a fighter jet, constructed in accordance with an embodiment of the present disclosure.

FIG. 11 is a side view of an aircraft, more specifically a fighter jet, constructed in accordance with an embodiment of the present disclosure.

FIG. 12 is a perspective view of a foreplane constructed in accordance with an embodiment of the present disclosure.

FIG. 13 is a cross-sectional view of a fuselage of a plane taken along the line 13-13 in FIG. 4.

FIG. 14 is a perspective view of an aircraft, more specifically a helicopter, constructed in accordance with an embodiment of the present disclosure.

FIG. 15 is a perspective view of a landing gear constructed in accordance with an embodiment of the present disclosure.

FIG. 16 is a cross-sectional view of a landing gear constructed in accordance with an embodiment of the present disclosure.

FIG. 17 is a perspective view of a cockpit of an aircraft constructed in accordance with an embodiment of the present disclosure and detailing an instrumentation panel.

FIG. 18 is a side view of a seat of an aircraft constructed in accordance with an embodiment of the present disclosure.

FIG. 19 is a side view of an aircraft, specifically a seaplane, constructed in accordance with an embodiment of the present disclosure.

FIG. 20 is an over-plated heating element constructed in accordance with an embodiment of the present disclosure.

It should be understood that the drawings are not necessarily drawn to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments disclosed herein.

### DETAILED DESCRIPTION

Unmanned Aerial Vehicle Components

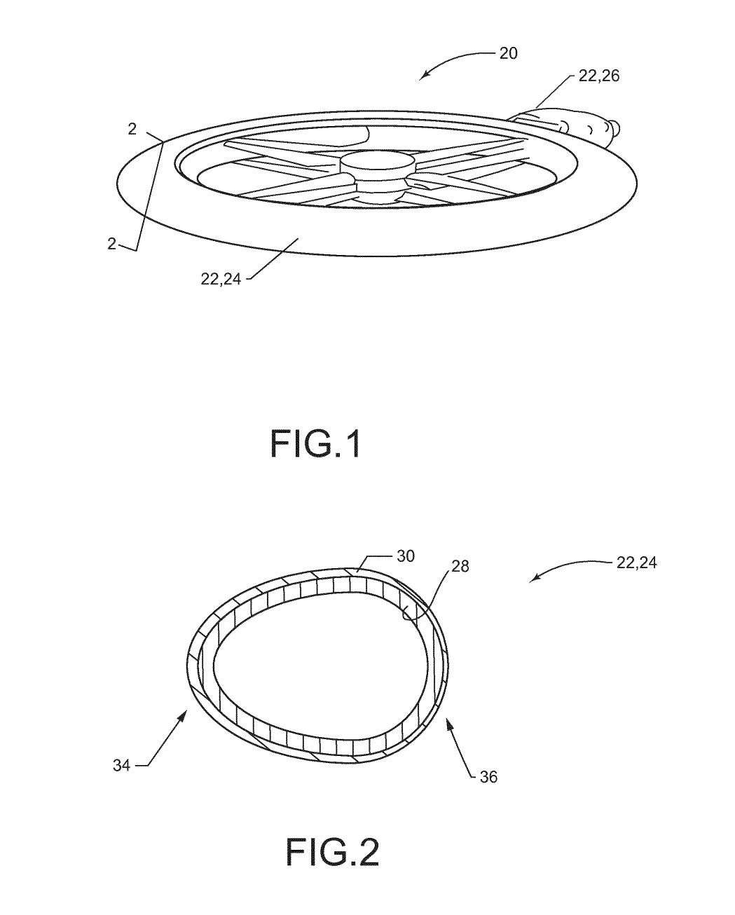

Unmanned aerial vehicles (UAVs) 20, such as the UAV illustrated in FIG. 1, are typically constructed from a plurality of components 22 that require high stiffness, strength, and low weight. Such components may include a fuselage 24, ducts 26, wings, and the like. These and other components may be complex and are typically constructed from costly materials by costly manufacturing methods. Plated polymers introduce new lower cost construction methods or allow for the creation of lighter components suitable for UAVs as opposed to traditional methods and materials. Such plated polymeric UAV components 22 include a polymeric substrate 28 and a plated layer 30 as illustrated in FIG. 2.

The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass. The substrate 28 may be fabricated into any desired shape such as, but not limited to, an airfoil shape such as commonly utilized in UAV wings or a hollow ring such as the fuselage 24 illustrated in FIG. 2. These components 22 may be formed by many methods including, but not limited to, injection-molding, compression-molding, blow-molding, additive manufacturing (including liquid bed, powder bed, and deposition processes), or composite-layup (including autoclave, compression, and liquid molding).

Once the substrate 28 has been formed, some mounting features such as, but not limited to, flanges or bosses may be bonded to the substrate 28 using a suitable adhesive. This boding may take place after molding of the substrate 28, but before applying the plated layer 30 to simplify the mold tooling.

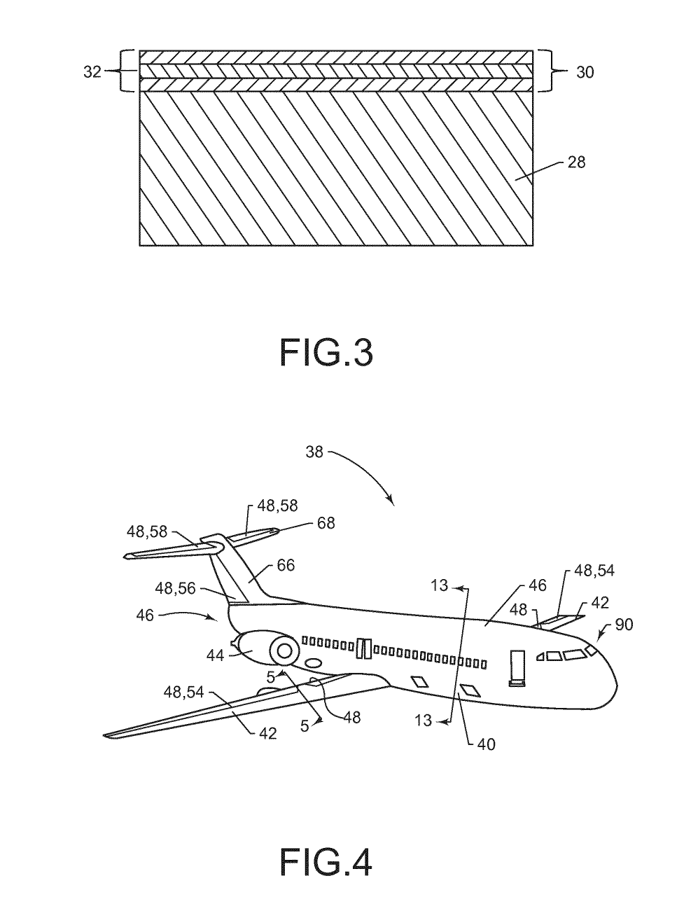

After any additional mounting features are added to the molded substrate 28, the plated layer 30 may be applied by a number of methods including electroless plating, electroplating, or electroforming. The plated layer 30 may include a plurality of metallic layers 32, as illustrated in FIG. 3, to increase the thickness of the plated layer 30 to any desired thickness. For example, one exemplary plated layer 30 may have a thickness in the range of about 0.0001 inches to about 0.025 inches where an average thickness may be between about 0.001 to about 0.02 inches. This range of thicknesses may provide an adequate resistance to erosion, impact, foreign-object damage, and the like for UAV components 22 exposed to the environment; examples of such components are the fuselage 24, ducts 26, and wings. This thickness range also preserves the option to finish the plated layer 30 more aggressively to meet tight tolerances, surface finish requirements, and the like.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, components having these stronger interfacing bonds between the plated layer 30 and substrate 28 may be desirable for UAV components that may experience high temperatures such as, but not limited to, exhaust ducts or engine coverings.

The plated layer 30 may be applied in multiple steps, where, during some steps, desired areas of the UAV components 22 may be masked to achieve different thicknesses in different areas of the components 22 or to leave an area bare of metallic layers 32 altogether. One example of this varying thickness profile is illustrated in FIG. 2, where a windward surface 34 of the fuselage 24 has a thicker plated layer 30 than a leeward surface 36 of the fuselage 24. Such a thickness profile may be desirable as wind and debris may assail the windward surface 34 more than the leeward surface 36 during operation. The customized plating thickness profile can also be achieved by tailored racking including, but not limited to, masking, shields, thieves, and conformal anodes. A customized plating thickness profile may allow for optimization of certain advantageous properties of the UAV components 22 such as, but not limited to, fire resistance, structural support, and surface characteristics without adding additional weight to the component 22 as compared to providing an even plated layer 30 thickness across the entire component 22.

The UAV component 22 may also be fabricated in multiple segments. This allows for complex geometries to be formed by forming simpler segments and then combining these segments into larger portions of the UAV 20. Each segment may be formed as described above, and then joined by any known means including, but not limited to, ultrasonic welding, laser welding, friction welding, friction-stir welding, traditional welding, adhesive, and miter joints with or without adhesive. Component segments joined by these methods may be joined before applying the plated layer 30 since many of the above joining methods may damage the plated layer 30. However, by utilizing transient liquid phase (TLP) bonding the component segments may be fabricated and plated individually and subsequently bonded as TLP bonding may not damage the substrate 28.

Once the plated layer 30 is applied, some additional features may be added such as, but not limited to, bosses, flanges, or inserts. These features may be joined to the part by using an adhesive, riveting, and the like. Polymeric coatings may also be applied once the plated layer 30 is fully applied. These coatings may be applied by conventional means such as spray coating or dip coating and may be applied to the entire component 22 or to localized areas only, as desired. For example, areas of the UAV component 22 that are left un-plated may also be left un-coated by the polymer since the polymeric substrate 28 is already exposed. Coating the plated polymeric UAV component 22 with a polymer allows for light-weight, stiff, and strong polymeric appearing or non-conductive, components.

From the foregoing, it can therefore be seen that UAV components may be formed from plated polymers to form light-weight, stiff, and strong components that may be cheaper in material cost, construction costs, and maintenance costs relative to traditional materials and methods.

Aviation Component—Aircraft Wing

Modern aircraft 38, the passenger plane illustrated in FIG. 4 for example, typically include a fuselage 40, a source of lift (a pair of fixed wings 42), a source of thrust (gas turbine engines 44 in this case), an empennage 46, and a plurality of control surfaces 48. The wings 42 are designed to create lift as air flows around them. This lift is required for the aircraft 38 to takeoff and remain flying and, thus, the wings 42 remain operative throughout flight. To do so, the wings 42 require a controlled stiffness and high strength. Low weight is also a desirable feature in all aircraft components. Additionally, the wings 42 also require high fatigue life, impact resistance, load-carrying capability, and erosion resistance to allow the wings 42 to remain functional throughout flight and reduce maintenance time and costs. As the wings 42 are flight-critical components, high-cost manufacturing methods and materials are typically employed to ensure the wings 42 meet these requirements. The introduction of plated polymers potentially allows the wings 42 to meet these requirements at a lower material and construction cost than previous construction methods.

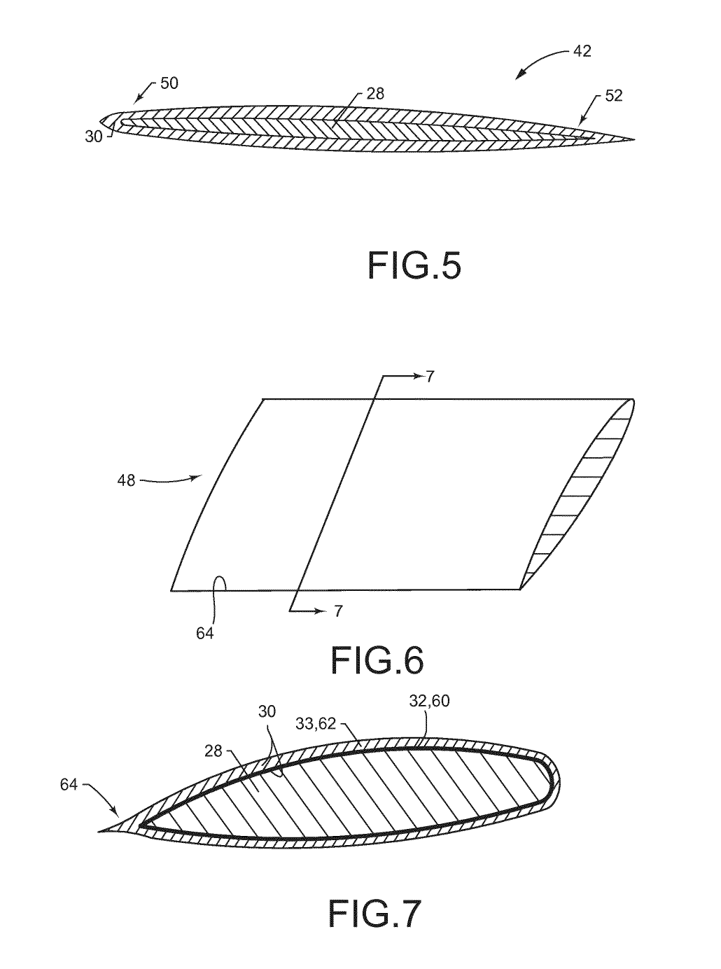

The wings 42 of the present disclosure are formed of a polymeric substrate 28 and a plated layer 30. The substrate 28 may be fabricated into any suitable wing shape, such as the airfoil shape illustrated in FIGS. 4 and 5, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass, to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.050 inches to about 2 inches. Other thicknesses are also possible and these ranges should not be considered limiting, but exemplary embodiments of the substrate 28 used to form the wing 42.

After forming the substrate 28, some mounting feature such as flanges, bosses, or the like may be bonded onto the substrate 28, using a suitable adhesive, to simplify the mold tooling. However, some features may alternatively be bonded to the wing 42 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness in the range 0.01-0.25 inches, where the average thickness is from about 0.025 inches to about 0.25 inches. These exemplary thickness ranges may provide adequate resistance to erosion, impact, and foreign-object damage for the wing 42. This thickness may also allow the plated layer 30 to be finished more aggressively to meet tight tolerances or surface finish requirements. However, other plated layer thicknesses are also possible and the ranges provided herein should not be considered limiting, but merely one embodiment of a wing 42.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, areas of the wings 42 near to the gas turbine engines 44 may experience temperatures that would otherwise damage the plated polymer, having these stronger interfacing bonds between the plated layer 30 and substrate 28 may allow the wing 42 to resist this damage.

The metallic layers 32 may also be selectively applied to certain areas of the substrate 28 to create a non-uniform thickness profile. This may be accomplished by masking certain portions of the substrate 28 as the metallic layers 32 are applied. For instance, the illustrated wing 42 in FIG. 5 has a thick plated layer 30 at a leading edge 50 of the wing 42 that tapers off towards a trailing edge 52 of the wing 42 where the plated layer 30 is thinner. This may be desirable for wings 42 where the leading edge 50 may be eroded by incoming air and debris and, thus, require a protective layer whereas the trailing edge 52 may not be eroded by the air or debris. The non-uniform thickness profile may also be achieved by tailored racking, including shields, thieves, conformal anodes, and the like. However formed, the non-uniform thickness profile may allow for optimization of properties of the wing 42 such as, but not limited to, fire resistance, structural support, and surface characteristics. By selectively applying the metallic layers 32 to areas of need these qualities may be optimized, while not adding additional weight to the wing 42.

The wing 42 may also be constructed from multiple segments of substrate 28 that are each individually formed and then joined by any conventional process. Complex or large geometries may thus be formed by fabricating simple or small substrate segments and then joining the segments together later. Such processes for joining the segments include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the wing 42.

Once the plated layer 30 has been applied to the substrate 28, or substrate segments, additional features may be attached. Such features may include bosses, flanges, or inserts and may be attached by adhesive, riveting, and the like. A polymeric coating may also be applied to the wing 42, once the plated layer 30 has been fully applied, to produce a light-weight, stiff, and strong polymeric appearing, non-conductive, wing 42. This coating may be applied to the entire wing 42 or to specific areas of the wing 42, as desired, by any conventional process such as spray coating or dip coating. For example, areas of the fuselage 40 where a plated layer 30 was not applied may also not receive a polymeric coating since these areas already expose the polymeric substrate 28.

From the foregoing it can be seen that a wing formed from plated polymers can provide the necessary qualities a wing for an aircraft must exhibit such as, but not limited to, control for stiffness variation, high strength, low weight , high fatigue life, impact resistance, load-carrying capability, and erosion resistance. Further, these qualities can be optimized in the necessary areas without adding undue weight to the wing. The materials required to form a plated polymer wing are also cheaper and more readily available than typical wing materials. As such, plated polymer wings and the methods used to form such wings can provide many added benefits over the traditional wings and methods found in the industry.

Aviation Component—Aircraft Control Surfaces

Modern aircraft 38, such as the passenger plane illustrated in FIG. 4, typically include a fuselage 40, a source of lift (a pair of fixed wings 42), a source of thrust (gas turbine engines 44 in this case), an empennage 46, and a plurality of control surfaces 48. The control surfaces 48 are designed to reorient the aircraft 38 by redirecting air as it travels across the aircraft 38. For example, the control surfaces 48 illustrated in FIG. 4 on the wings 42, also called ailerons 54, allow a pilot to control a roll of the aircraft, while the control surfaces 48 on the empennage 46, also called a rudder 56 and elevators 58, allow the pilot to control a yaw and pitch of the aircraft 38. Air speed and altitude may also be adjusted with the control surfaces 48 by positioning the control surface 48 to increase drag on the aircraft 38. The control surfaces 48 require a controlled stiffness and high strength to endure the stresses of flight, and a low weight is typically desirable in all aircraft components to allow the aircraft 38 to have a higher load capacity. Additionally, the control surfaces 48 also require high fatigue life, impact resistance, load-carrying capability, and erosion resistance to remain functional throughout flight and reduce maintenance time and costs. As the control surfaces 48 are flight-critical components, high-cost manufacturing methods and materials are typically employed to ensure the control surfaces 48 meet these requirements. The introduction of plated polymers potentially allows the control surfaces 48 to meet these requirements at a lower material and construction cost than previous construction methods.

The control surfaces 48 of the present disclosure are formed of a polymeric substrate 28 and a plated layer 30. The substrate 28 may be fabricated into any suitable shape, such as the airfoil shape illustrated in FIG. 6, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass, to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a substrate 28 used to form a control surface 48.

After forming the substrate 28, some mounting features such as flanges, bosses, or the like may be bonded onto the substrate 28, using a suitable adhesive, to simplify the mold tooling. However, some features may alternatively be bonded to the control surface 48 once the plated layer 30 has been applied.

The plated layer 30 may be applied in a number of metallic layers 32, as illustrated in FIGS. 3 and 7, up to any desired thickness. Each of these metallic layers 32 may be applied by electroless plating, electroplating, or electroforming until the desired thickness is achieved. One exemplary plated layer 30 may have a thickness in the range 0.010-0.250 inches with an average thickness from about 0.025 inches to about 0.250 inches. This range of thicknesses may provide adequate resistance to erosion, impact, and foreign-object damage for the control surfaces 48, and may also allow the plated layer 30 to be finished more aggressively to meet tight tolerances or surface finish requirements. However, other plated layer thicknesses area also possible and the ranges provided herein should not be considered limiting, but merely one embodiment of a control surface 48.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymer by increasing interfacing bond strength or preventing the plated layer 30 from peeling away from the substrate 28. For example, hot exhaust from a gas turbine engine 44 may flow across some control surfaces 48 such as the ailerons 54, these stronger interfacing bonds between the plated layer 30 and substrate 28 may allow the plated polymeric structure to resist heat damage that may otherwise be inflicted upon the control surface 48.

The metallic layers 32 may also be selectively applied to certain areas of the substrate 28 to create a non-uniform thickness profile. This may be accomplished by masking desired portions of the substrate 28 as the metallic layers 32 are applied. For instance, the illustrated control surface 48 in FIG. 7 has two metallic layers 32; a first layer 60 that is uniformly applied to the entire control surface 48 and a second layer 62 that is uniformly applied to the control surface 48 except at a trailing edge 64 of the control surface 48. At the trailing edge 64 the second layer 62 is built up to form a tapered shape extending away from the substrate 28. This may be desirable as the second metallic layer 64 may be formed into a thinner shape than possible with the substrate 28 while still retaining the stiffness and strength required by the control surface 48. The non-uniform thickness profile may also be achieved by tailored racking, including shields, thieves, conformal anodes, and the like.

However formed, the non-uniform thickness profile may allow for optimization of properties of the control surface 48 such as, but not limited to, fire resistance, structural support, and surface characteristics. By selectively applying the metallic layers 32 to areas of need these qualities may be optimized, while not adding additional weight to the control surface 48. While particular control surface configurations are described herein and illustrated in FIGS. 6 and 7, these are intended to only be exemplary embodiments of a plated polymeric control surface and should not be considered limiting.

The control surface 48 may also be constructed from multiple segments of substrate 28 that are each individually formed and then joined by any conventional process. Complex or large geometries may thus be formed by fabricating simple or small substrate segments and then joining these segments together. Such processes for joining the segments include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the control surface 48.

Once the plated layer 30 has been applied to the substrate 28, or substrate segments, additional features may be attached. Such features may include bosses, flanges, or inserts and may be attached by adhesive, riveting, and the like. A polymeric coating may also be applied to the control surface 48, once the plated layer 30 has been fully applied, to produce a light-weight, stiff, and strong polymeric appearing, non-conductive, control surface 48. This coating may be applied to the entire control surface 48 or to specific areas of the control surface 48, as desired, by any conventional process such as spray coating or dip coating. For example, areas of the control surface 48 where a plated layer 30 was not applied may also not receive a polymeric coating since the polymer substrate 28 is already exposed.

From the foregoing it can be seen that a control surface formed from a plated polymer potentially provides the necessary qualities a control surface for an aircraft must exhibit such as, but not limited to, control for stiffness variation, high strength, low weight, high fatigue life, impact resistance, load-carrying capability, and erosion resistance. Further, these qualities can be optimized in the necessary areas without adding undue weight to the control surface. The materials required to form a plated polymeric control surface are also cheaper and more readily available than typical materials. As such, plated polymeric control surfaces and the methods used to form such control surfaces can provide many added benefits over the traditional materials and methods found in the industry.

Aviation Component—Aircraft Empennage

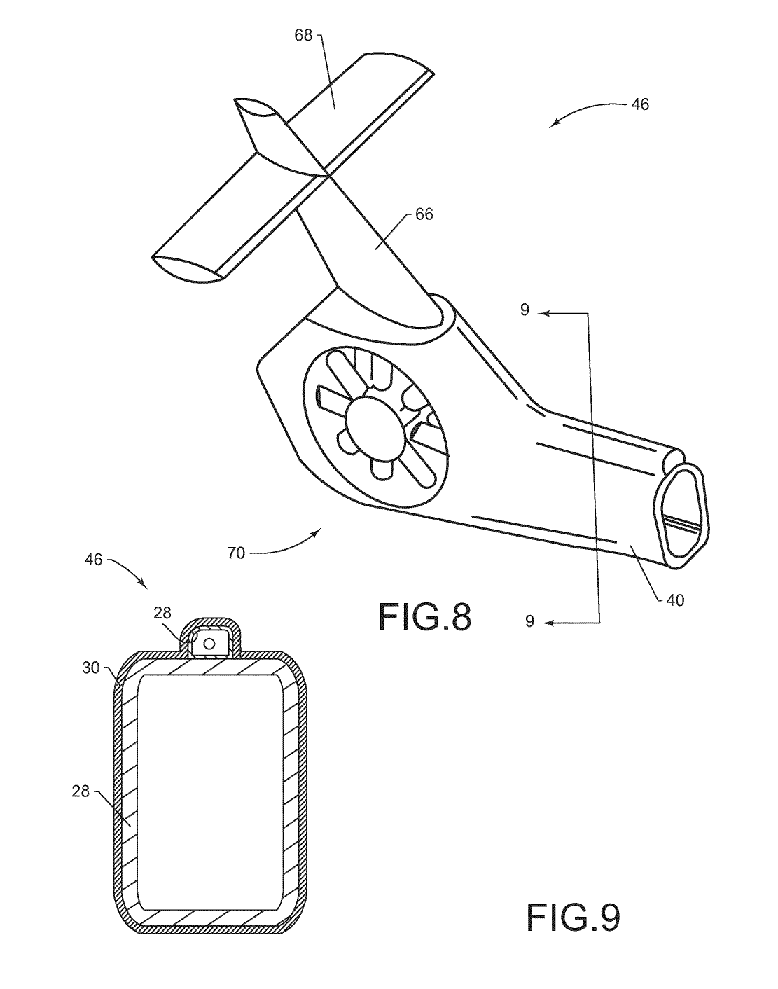

Modern aircraft 38, such as the passenger plane illustrated in FIG. 4, typically include a fuselage 40, a source of lift (a pair of fixed wings 42), a source of thrust (gas turbine engines 44 in this case), an empennage 46, and a plurality of control surfaces 48. The empennage 46 of an aircraft is located at the tail of the aircraft and typically includes a portion of the fuselage 40, stabilizers, such as a vertical stabilizer 66 and a horizontal stabilizer 68, and control surfaces 48, such as a rudder 56 and an elevator 58. These components cooperate to form the empennage 46 and gives stability to the aircraft 38, whether that aircraft is a plane, a helicopter, or another form of aircraft. An empennage 46 of a helicopter is illustrated in FIG. 8 and may include a portion of the fuselage 40, the vertical and horizontal stabilizers 66 and 68, and a rotor 70 to assist in yaw control and to counteract torque generated by a main rotor of the helicopter. In general, empennages 46 require a controlled stiffness and high strength to endure the stresses of flight, and a low weight is typically desirable in all aircraft components to allow the aircraft 38 to have a higher load capacity. Additionally, the empennage 46 also requires high fatigue life, impact resistance, load-carrying capability, and erosion resistance to remain functional throughout flight and reduce maintenance time and costs. As the empennage 46 is a flight-critical component, high-cost manufacturing methods are typically employed to ensure the empennage 46 meets these requirements. The introduction of plated polymers potentially allows the empennage 46 to meet these requirements at a lower material and construction cost than traditional materials and methods.

The empennage 46 of the present disclosure is formed of a polymeric substrate 28 and a plated layer 30. The substrate 28 may be fabricated into any suitable shape, such as the shapes illustrated in FIGS. 8 and 9, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a substrate 28 used to form an empennage 46.

After forming the substrate 28, some mounting feature such as flanges, bosses, or the like may be bonded onto the substrate 28, using a suitable adhesive, to simplify the mold tooling. However, some features may alternatively be bonded to the empennage 46 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.01 inches to about 0.25 inches with an average thickness from about 0.025 inches to about 0.25 inches. This range of thicknesses may provide adequate resistance to erosion, impact, and foreign-object damage for the empennage 46, and may also allow the plated layer 30 to be finished more aggressively to meet tight tolerances or surface finish requirements. However, other plated layer thicknesses area also possible and the ranges provided herein should not be considered limiting, but merely one embodiment of an empennage 46.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymer by increasing interfacing bond strength or preventing the plated layer 30 from peeling away from the substrate 28. For example, hot exhaust from a gas turbine engine 44 may flow across the empennage 46, these stronger interfacing bonds between the plated layer 30 and substrate 28 may allow the plated polymeric structure to resist heat damage that may otherwise be inflicted upon the empennage 46.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the empennage 46 such as, but not limited to, fire resistance, structural support, and surface characteristics. By selectively applying the metallic layers 32 to areas of need these qualities may be optimized, while not adding additional weight to the empennage 46. While particular empennage configurations are described herein and illustrated in FIGS. 4, 8, and 9, these are intended to only be exemplary embodiments of a plated polymeric empennage and should not be considered limiting.

The empennage 46 may also be constructed from multiple segments of substrate 28 that are each individually formed and then joined by any conventional process. Complex or large geometries may thus be formed by fabricating simple or small substrate segments and then joining these segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the empennage 46.

Once the plated layer 30 has been applied to the substrate 28, or substrate segments, additional features may be attached. Such features may include bosses, flanges, or inserts and may be attached by adhesive, riveting, and the like. A polymeric coating may also be applied to the empennage 46, once the plated layer 30 has been fully applied, to produce a light-weight, stiff, and strong polymeric appearing, non-conductive, empennage 46. This coating may be applied to the entire empennage 46 or to specific areas of the empennage 46, as desired, by any conventional process such as spray coating or dip coating. For example, areas of the empennage 46 where a plated layer 30 was not applied may also not receive a polymeric coating since the polymeric substrate 28 is already exposed.

From the foregoing it can be seen that an empennage formed from a plated polymer potentially provides the necessary qualities an empennage for an aircraft must exhibit such as, but not limited to, control for stiffness variation, high strength, low weight , high fatigue life, impact resistance, load-carrying capability, and erosion resistance. Further, these qualities can be optimized in the necessary areas without adding undue weight to the empennage. The materials required to form a plated polymeric empennage are also cheaper and more readily available than typical materials. As such, plated polymeric empennage and the methods used to form such empennage can provide many added benefits over the traditional materials and methods found in the industry.

Aviation Component—Aircraft Foreplane

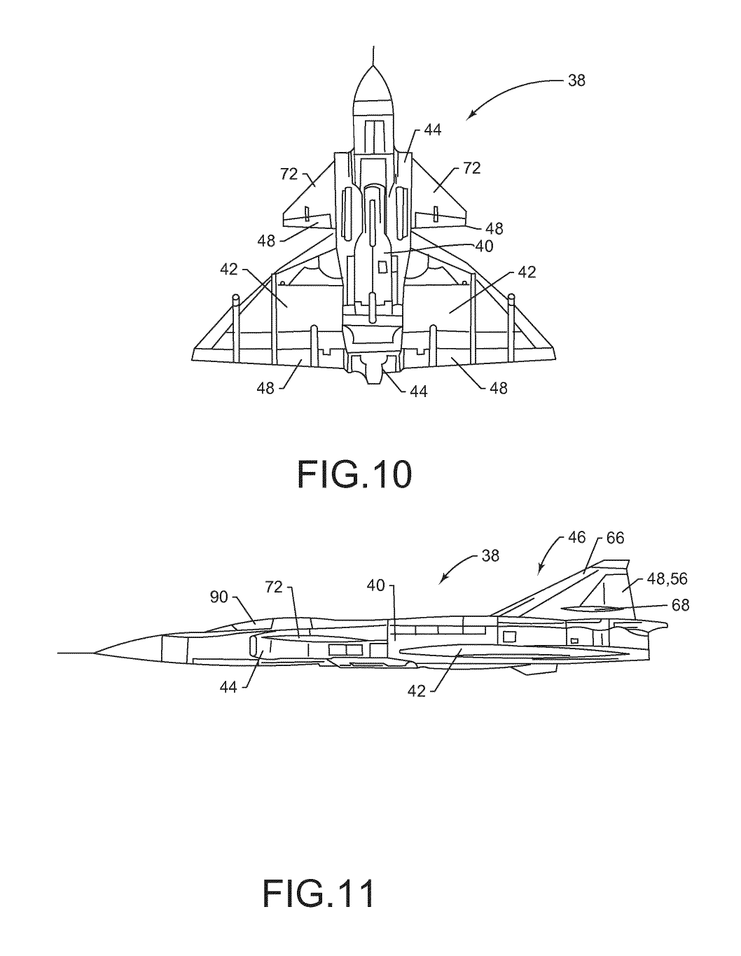

Some aircraft 38, such as the fighter jet illustrated in FIG. 10, may include a fuselage 40, a source of lift (a pair of fixed wings 42), a source of thrust (a gas turbine engine 44 in this case), an empennage 46, a plurality of control surfaces 48, and a pair of foreplanes 72, also known as canards. The foreplane 72 is a lateral surface positioned on the aircraft 38 forward of the wings 42 and may be used to generate lift, as a stabilizer, as another control surface to enhance a pilot's control of the aircraft 38, or to reduce turbulence and vibration in the aircraft 38. As air flows across the foreplane 72, stresses are imparted to the foreplane 72 and thus it requires controlled stiffness and high strength to resist deformation and damage. A low weight is also beneficial for the foreplane 72 as in all aircraft components since reducing weight allows the aircraft 38 to have a larger carrying capacity. Additionally, the foreplane 72 also requires high fatigue life, impact resistance, load-carrying capability, and erosion resistance to remain functional throughout flight and reduce maintenance time and costs. As the foreplane 72 is a flight-critical component, high-cost manufacturing methods and materials are typically employed to ensure the foreplane 72 meets these requirements. The introduction of plated polymers potentially allows the foreplane 72 to meet these requirements at a lower material and construction cost than traditional materials and methods.

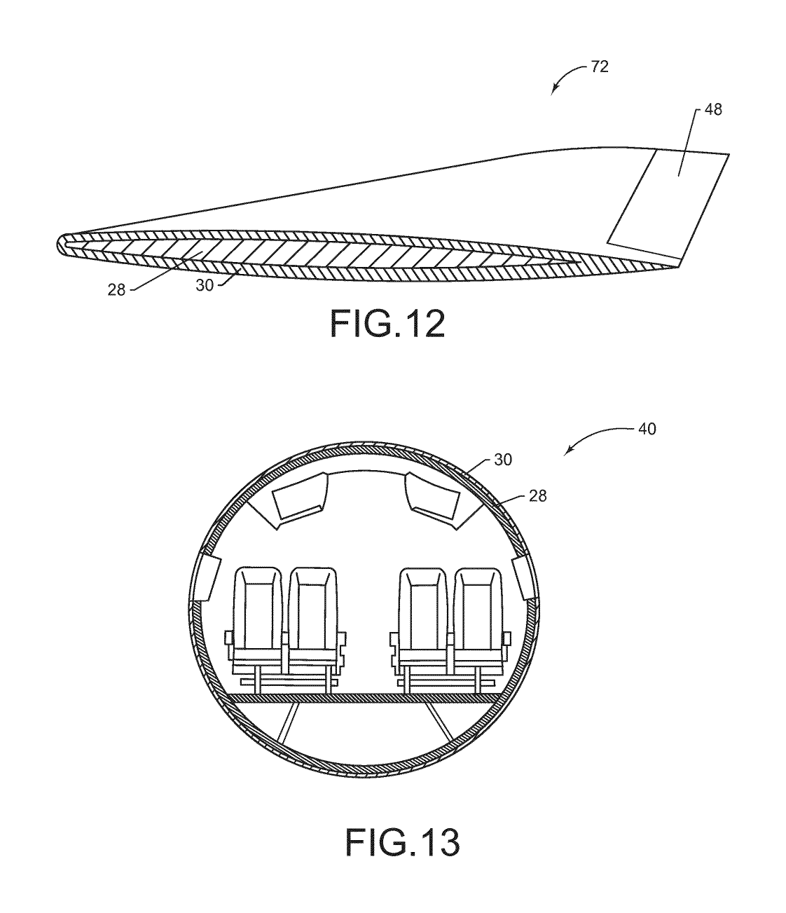

The foreplane 72 of the present disclosure is formed of a polymeric substrate 28 and a plated layer 30. The substrate 28 may be fabricated into any suitable shape, such as the airfoil shape illustrated in FIG. 12, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a polymeric substrate 28 used to form a foreplane 72.

After forming the substrate 28, some mounting features such as flanges, bosses, or the like may be bonded onto the substrate 28, using a suitable adhesive, to simplify the mold tooling. However, some features may alternatively be bonded to the foreplane 72 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.01 inches to about 0.25 inches with an average thickness that may range from about 0.025 inches to about 0.25 inches. This range of thicknesses may provide adequate resistance to erosion, impact, and foreign-object damage for the foreplane 72, and may also allow the plated layer 30 to be finished more aggressively to meet tight tolerances or surface finish requirements. However, other plated layer thicknesses area also possible and the ranges provided herein should not be considered limiting, but merely one embodiment of a foreplane 72.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, aircraft 38 operating in hot environments may be subjected to temperatures that may otherwise damage a plated polymeric foreplane 72, these stronger interfacing bonds between the plated layer 30 and substrate 28 may allow the plated polymeric structure to resist such heat damage.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the foreplane 72 such as, but not limited to, fire resistance, structural support, and surface characteristics. By selectively applying the metallic layers 32 to areas of need these qualities may be optimized, while not adding additional weight to the foreplane 72. While particular foreplane configurations are described herein and illustrated in FIGS. 10-12, these are intended to only be exemplary embodiments of a plated polymer foreplane and should not be considered limiting.

The foreplane 72 may also be constructed from multiple segments of substrate 28 that are each individually formed and then joined by any conventional process. Complex or large geometries may thus be formed by fabricating simple or small substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the foreplane 72.

Once the plated layer 30 has been applied to the substrate 28, or substrate segments, additional features may be attached. Such features may include bosses, flanges, or inserts and may be attached by adhesive, riveting, and the like. A polymeric coating may also be applied to the foreplane 72, once the plated layer 30 has been fully applied, to produce a light-weight, stiff, and strong polymeric appearing, non-conductive, foreplane 72. This coating may be applied to the entire foreplane 72 or to specific areas of the foreplane 72, as desired, by any conventional process such as spray coating or dip coating. For example, areas of the foreplane 72 where a plated layer 30 was not applied may also not receive a polymeric coating since the polymeric substrate 28 is already exposed.

From the foregoing it can be seen that a foreplane formed from a plated polymer potentially provides the necessary qualities a foreplane for an aircraft must exhibit such as, but not limited to, control for stiffness variation, high strength, low weight , high fatigue life, impact resistance, load-carrying capability, and erosion resistance. Further, these qualities can be optimized in the necessary areas without adding undue weight to the foreplane. The materials required to form a plated polymeric foreplane are also cheaper and more readily available than typical materials. As such, plated polymeric foreplane and the methods used to form such foreplane can provide many added benefits over the traditional materials and methods found in the industry.

Aviation Component—Aircraft Fuselage

Modern aircraft 38, such as the passenger plane illustrated in FIG. 4 for example, may include a fuselage 40, a source of lift (a pair of fixed wings 42), a source of thrust (gas turbine engines 44 in this case), an empennage 46, and a plurality of control surfaces 48. As air flows across the fuselage 40 stresses may be imparted to the fuselage 40. As such, the fuselage 40 must have controlled stiffness and high strength to resist deformation and damage. Additionally, low weight components are typically more desirable in aviation applications to increase load carrying capacity of the aircraft 38, thus the fuselage 40 may also require low weight. Further, the fuselage 40 also requires high fatigue life, impact resistance, load-carrying capability, and erosion resistance to remain functional throughout flight and reduce maintenance time and costs. As the fuselage 40 is a flight-critical component, high cost manufacturing methods and materials are typically employed to ensure the fuselage 40 meets these requirements. The introduction of plated polymers potentially allows the fuselage 40 to meet these requirements at a lower material and construction cost than traditional materials and methods.

The fuselage 40 of the present disclosure is formed of a polymeric substrate 28 and a plated layer 30. The substrate 28 may be fabricated into any suitable shape, such as the “double-bubble” shape illustrated in FIG. 13, by many methods including, but not limited to, injection-molding, compression-molding, additive manufacturing(including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a substrate 28 used to form a fuselage 40.

After forming the substrate 28, some mounting features such as flanges, bosses, or the like may be bonded onto the substrate 28, using a suitable adhesive, to simplify the mold tooling. However, some features may alternatively be bonded to the fuselage 40 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.01 inches to about 0.25 inches with an average thickness from about 0.025 inches to about 0.25 inches. This range of thicknesses may provide adequate resistance to erosion, impact, and foreign-object damage for the fuselage 40, and may also allow the plated layer 30 to be finished more aggressively to meet tight tolerances or surface finish requirements. However, other thicknesses are also possible and the ranges presented herein are merely an exemplary embodiment of the plated layer 30 and should not be considered limiting.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, hot exhaust from a gas turbine engine 44 may flow across the fuselage 40, these stronger interfacing bonds between the plated layer 30 and substrate 28 may allow the plated polymeric structure to resist heat damage that may otherwise be inflicted upon the fuselage 40.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the fuselage 40 such as, but not limited to, fire resistance, structural support, and surface characteristics. By selectively applying the metallic layers 32 to areas of need these qualities may be optimized, while not adding additional weight to the fuselage 40. While particular fuselage configurations are described herein and illustrated in FIGS. 4 and 13, other fuselage configurations are also possible, such as the fuselages illustrated in FIGS. 10 and 11, for example. The illustrated fuselages 40 are intended to only be exemplary embodiments of a plated polymeric fuselage and should not be considered limiting.

The fuselage 40 may also be constructed from multiple segments of substrate 28 that are each individually molded and then joined by any conventional process. Complex or large geometries may thus be formed by fabricating simple or smaller substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the fuselage 40 since the polymeric substrate 28 is already exposed.

Once the plated layer 30 has been applied to the substrate 28, or substrate segments, additional features may be attached. Such features may include bosses, flanges, or inserts and may be attached by adhesive, riveting, and the like. A polymeric coating may also be applied to the fuselage 40, once the plated layer 30 has been fully applied, to produce a light-weight, stiff, and strong polymeric appearing, non-conductive, fuselage 40. This coating may be applied to the entire fuselage 40 or to specific areas of the fuselage 40, as desired, by any conventional process such as spray coating or dip coating. For example, areas of the fuselage 40 where a plated layer 30 was not applied may also not receive a polymeric coating.

From the foregoing it can be seen that a fuselage formed from a plated polymer potentially provides the necessary qualities a fuselage for an aircraft must exhibit such as, but not limited to, control for stiffness variation, high strength, low weight , high fatigue life, impact resistance, load-carrying capability, and erosion resistance. Further, these qualities can be optimized in necessary areas without adding undue weight to the fuselage. The materials required to form a plated polymeric fuselage are also cheaper and more readily available than typical materials. As such, plated polymer fuselage and the methods used to form such fuselage can provide many added benefits over the traditional materials and methods found in the industry.

Aircraft Component—Aircraft Landing Gear

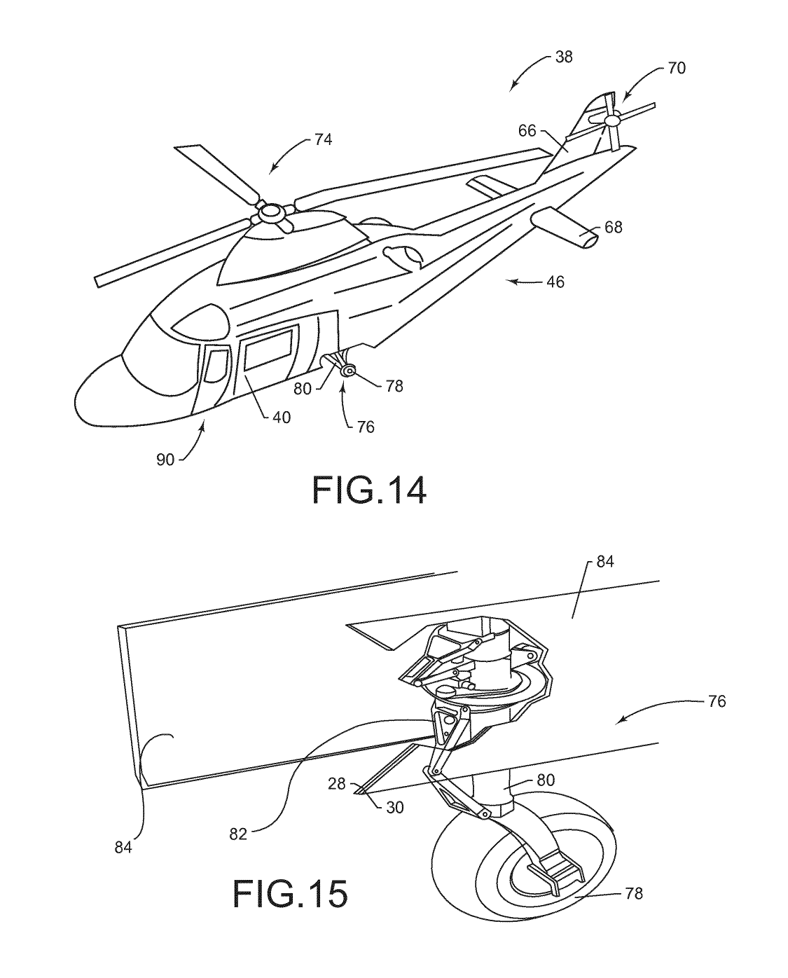

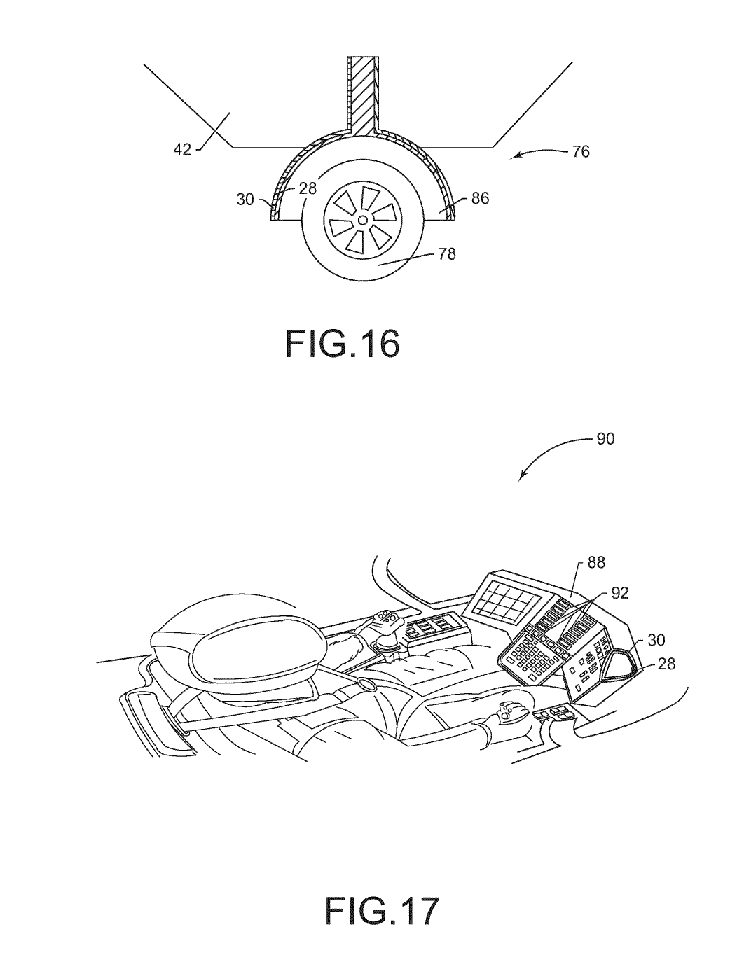

Modern aircraft 38, such as the helicopter illustrated in FIG. 14 for example, may include a fuselage 40, a source of lift (a primary rotor 74 in this case), a source of thrust (also the primary rotor 74), an empennage 46, and at least one landing gear 76. The landing gear 76 is designed to support the aircraft 38 while on the ground and can take the form of a rail, a ski, or a wheel 78, as illustrated in FIGS. 14-16, as well as other structures. Referring to the wheeled landing gear in FIG. 15, a support 80 may attach to the fuselage 40 and the wheel 78 to position the wheel 78 below the aircraft 38. This support 80 may be mechanically associated with an actuator 82 to retract the wheel 78 once the aircraft 38 has taken off and then extend the wheel 78 when the aircraft 38 needs to land. A door 84 may also be incorporated into the landing gear 76, such that when the wheel 78 is retracted the door 84 is in a closed position covering the wheel 78. This door 84 may allow an underside of the aircraft 38 to be aerodynamically smooth during flight, but also allow the wheel 78 to extend during landing and takeoff. Another configuration for a wheeled landing gear is illustrated in FIG. 16, where the wheel 78 is held in an extended position below the wing 42 at all times by the support 80. Since this wheel 78 cannot be retracted, a cover 86 may be positioned around the wheel 78 to create a more aerodynamic surface and reduce drag.

No matter the form the landing gear 76 takes, the elements of the landing gear 76, such as the support 80, door 84, ski, rail, etc., require controlled stiffness and high strength to withstand the stresses from air and debris while the landing gear 76 is extended and to support the weight of the aircraft 38. Additionally, the landing gear 76 typically constitutes a non-trivial percentage of the total weight of the aircraft 38. As such, a low weight is more desirable to increase the load capacity of the aircraft 38. Further, the landing gear 76 also requires high fatigue life, impact resistance, load-carrying capability, and erosion resistance to remain functional throughout it usage and reduce maintenance time and costs. As the landing gear 76 is a flight-critical component, primarily during takeoff and landing, high cost manufacturing methods and materials are typically employed to ensure the landing gear 76 meets these requirements. The introduction of plated polymers potentially allows the landing gear 76 to meet these requirements at a lower material and construction cost than traditional materials and methods.

The landing gear 76 of the present disclosure is formed of a polymeric substrate 28 and a plated layer 30. The substrate 28 may be fabricated into any suitable shape, such as the support 80 or door 84 illustrated in FIG. 15 or the cover illustrated in FIG. 16, by many methods including, but not limited to, injection-molding, compression-molding, additive manufacturing(including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polysulfone, polyamide, polyphenylsufide, polyester, polyimide, nylon, and combinations thereof. Suitable thermoset materials may include, but are not limited to, condensation polymidides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a substrate 28 used to form a landing gear 76.

After forming the substrate 28, some mounting features such as flanges, bosses, or the like may be bonded onto the substrate 28, using a suitable adhesive, to simplify the mold tooling. However, some features may alternatively be bonded to the landing gear 76 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.01 inches to about 0.25 inches with an average thickness from about 0.025 inches to about 0.15 inches. This range of thicknesses may provide adequate resistance to erosion, impact, and foreign-object damage for the landing gear 76, and may also allow the plated layer 30 to be finished more aggressively to meet tight tolerances or surface finish requirements. However, other thicknesses are also possible and the ranges presented herein are merely one exemplary embodiment of the plated layer 30 and should not be considered limiting.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymer by increasing interfacing bond strength or preventing the plated layer 30 from peeling away from the substrate 28. For example, heat may be generated by friction between the wheel 78 and the ground during takeoff and landing, this heat may be transferred to plated polymeric components, these stronger interfacing bonds between the plated layer 30 and substrate 28 may allow the plated polymeric structure to resist this heat that may have otherwise damaged these components.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the landing gear 76 such as, but not limited to, fire resistance, structural support, and surface characteristics. By selectively applying the metallic layers 32 to areas of need these qualities may be optimized, while not adding additional weight to the landing gear 76. While particular landing gear configurations are described herein and illustrated in FIGS. 14 - 16, other landing gear configurations are also possible. The illustrated landing gears 74 are intended to only be exemplary embodiments of a plated polymeric landing gear and should not be considered limiting.

The landing gear 76 may also be constructed from multiple segments of substrate 28 that are each individually formed and then joined by any conventional process. Complex or large geometries may thus be formed by fabricating simple or smaller substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the landing gear 76.

Once the plated layer 30 has been applied to the substrate 28, or substrate segments, additional features may be attached. Such features may include bosses, flanges, or inserts and may be attached by adhesive, riveting, and the like. A polymeric coating may also be applied to the landing gear 76, once the plated layer 30 has been fully applied, to produce a light-weight, stiff, and strong polymeric appearing, non-conductive, landing gear 76. This coating may be applied to the entire landing gear 76 or to specific areas of the landing gear 76, as desired, by any conventional process such as spray coating or dip coating. For example, areas of the landing gear 76 where a plated layer 30 was not applied may also not receive a polymeric coating since the polymeric substrate 28 is already exposed.

From the foregoing it can be seen that a landing gear formed from a plated polymer potentially provides the necessary qualities a landing gear for an aircraft must exhibit such as, but not limited to, control for stiffness variation, high strength, low weight, high fatigue life, impact resistance, load-carrying capability, and erosion resistance. Further, these qualities can be optimized in necessary areas without adding undue weight to the landing gear. The materials required to form a plated polymeric landing gear are also cheaper and more readily available than typical materials. As such, plated polymeric landing gear and the methods used to form such landing gear provide many added benefits over the traditional materials and methods found in the industry.

Aviation Component—Aircraft Instrumentation Panel

Modern aircraft 38, such as the passenger plane illustrated in FIG. 4 for example, may include a fuselage 40, a source of lift (a pair of fixed wings 42), a source of thrust (gas turbine engines 44 in this case), an empennage 46, and an instrumentation panel 88. One such instrumentation panel 88 is illustrated in FIG. 17 and positioned within a cockpit 90 of the aircraft 38. The instrumentation panel 88 is typically a panel or plurality of panels that include a plurality of flight instruments 92 including some or all of: an altimeter, an attitude indicator, an airspeed indicator, a magnetic compass, a heading indicator, a vertical-speed indicator, and other instruments. The panel 88 requires controlled stiffness and high strength to withstand the stresses of flight. A low weight is also typically desirable in all aircraft components to increase the load capacity of the aircraft 38. Further, the instrumentation panel 88 also requires high fatigue life and impact resistance, to remain functional throughout it usage and reduce maintenance time and costs. As the instrumentation panel 88 is a flight-critical component high-cost manufacturing methods and materials are typically employed to ensure the instrumentation panel 88 meets these requirements. The introduction of plated polymers potentially allows the instrumentation panel 88 to meet these requirements at a lower material and construction cost than traditional materials and methods.

The instrumentation panel 88 of the present disclosure is formed of a polymeric substrate 28 and a plated layer 30. The substrate 28 may be fabricated into any suitable shape, such as the “T-shaped” panel illustrated in FIG. 17, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The thickness of the substrate 28 may range from about 0.05 inches to about 0.25 inches when formed by injection molding. However, localized areas may range up to about 0.5 inches. Compression molding, on the other hand, may allow the substrate 28 to have a thickness from about 0.05 inches to about 2 inches. Other thicknesses are also possible and these ranges should not be considered limiting, but exemplary embodiments of a substrate 28 used to form an instrumentation panel 74.

After forming the substrate 28, some mounting features such as flanges, bosses, or the like may be bonded onto the substrate 28, using a suitable adhesive, to simplify the mold tooling. However, some features may alternatively be bonded to the instrumentation panel 88 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.001 inches to about 0.05 inches with an average thickness from about 0.001 inches to about 0.03 inches. This range of thicknesses may provide adequate resistance to erosion, impact, and foreign-object damage for the instrumentation panel 88, and may also allow the plated layer 30 to be finished more aggressively to meet tight tolerances or surface finish requirements. However, other thicknesses are also possible and the ranges presented herein are merely one exemplary embodiment of the plated layer 30 and should not be considered limiting.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, the instrumentation panel 88 may contain processors and data storage devices that may generate copious amounts of heat, and these stronger interfacing bonds between the plated layer 30 and substrate 28 may allow the plated polymer to resist this heat that may have otherwise damaged the plated polymeric instrumentation panel 88.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the instrumentation panel 88 such as, but not limited to, fire resistance, structural support, and surface characteristics. By selectively applying the metallic layers 32 to areas of need these qualities may be optimized, while not adding additional weight to the instrumentation panel 88. While particular instrumentation panel configurations are described herein and illustrated in FIG. 17, other instrumentation panel configurations are also possible. The illustrated instrumentation panel 88 is intended to only be an exemplary embodiment of a plated polymeric instrumentation panel and should not be considered limiting.

The instrumentation panel 88 may also be constructed from multiple segments of substrate 28 that are each individually formed and then joined by any conventional process. Complex or large geometries may thus be formed by fabricating simple or smaller substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the instrumentation panel 88.

Once the plated layer 30 has been applied to the substrate 28, or substrate segments, additional features may be attached. Such features may include bosses, flanges, or inserts and may be attached by adhesive, riveting, and the like. A polymeric coating may also be applied to the instrumentation panel 88, once the plated layer 30 has been fully applied, to produce a light-weight, stiff, and strong polymeric appearing, non-conductive, instrumentation panel 88. This coating may be applied to the entire instrumentation panel 88 or to specific areas of the instrumentation panel 88, as desired, by any conventional process such as spray coating or dip coating. For example, areas of the instrumentation panel 88 where a plated layer 30 was not applied may also not receive a polymeric coating since the polymeric substrate 28 is already exposed.

From the foregoing it can be seen that an instrumentation panel formed from a plated polymer potentially provides the necessary qualities an instrumentation panel for an aircraft must exhibit such as, but not limited to, high strength, low weight , high fatigue life, and impact resistance. Further, these qualities can be optimized in necessary areas without adding undue weight to the instrumentation panel. The materials required to form a plated polymeric instrumentation panel are also cheaper and more readily available than typical materials. As such, plated polymeric instrumentation panel and the methods used to form such instrumentation panels can provide many added benefits over the traditional materials and methods found in the industry.

Seat Components

Modern aircraft 38, such as the passenger plane illustrated in FIG. 4 for example, may include a fuselage 40, a source of lift (a pair of fixed wings 42), a source of thrust (gas turbine engines 44 in this case), an empennage 46, and a plurality of seats 94. The seats 94 may take a variety of forms, but one exemplary seat 94 is illustrated in FIG. 18. Each seat 94 typically includes a plurality of components 96 such as a chair arm 98, a leg 100, and a seat frame 102, as well as other components 96 and may weigh around seventy-five to eighty-five pounds. Taken together, the seats 94 may possess a non-trivial percentage of the weight of the aircraft 38, which may negatively affect load-carrying capacity or fuel economy. The introduction of plated polymers potentially allows the seats 94 to reduce weight compared to traditional materials and increase the load-carrying capacity and fuel economy of the aircraft 38.

Some components 96 of the present disclosure may be formed of a polymeric substrate 28 and a plated layer 30. Such components 96 may include the chair arm 98, the leg 100, and the seat frame 102. This is not an exhaustive list of the components 96 that may be formed of a plated polymer, but rather an exemplary list of components 96 and other components 96 can surely be formed from plated polymers as well. The substrate 28 may be fabricated into any suitable shape, such as the component shapes illustrated in FIG. 18, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The substrate 28 may be formed into any desired thickness, allowing great freedom in the construction of the seat 94 and components 96.

After forming the substrate 28, some mounting features such as flanges, bosses, or the like may be bonded onto the substrate 28, using a suitable adhesive, to simplify the mold tooling. However, some features may alternatively be bonded to the instrumentation panel 88 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.001 inches to about 0.05 inches with an average thickness from about 0.004 inches to about 0.03 inches. This range of thicknesses may provide adequate resistance to erosion, impact, and foreign-object damage for the components 96, and may also allow the plated layer 30 to be finished more aggressively to meet tight tolerances or surface finish requirements. However, other thicknesses are also possible and the ranges presented herein are merely one exemplary embodiment of the plated layer 30 and should not be considered limiting.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of large loads and fatigue on the plated polymer by increasing interfacing bond strength or preventing the plated layer 30 from peeling away from the substrate 28.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the components 96 such as, but not limited to, structural support and surface characteristics. By selectively applying the metallic layers 32 to areas of need these qualities may be optimized, while not adding additional weight to the component 96. While particular seat and seat component configurations are described herein and illustrated in FIG. 18, other seat and seat component configurations are also possible. The illustrated seat 94 and components 96 are intended to only be an exemplary embodiment of a plated polymeric seat and should not be considered limiting.

The seat 94 and components 96 may also be constructed from multiple segments of substrate 28 that are each individually formed and then joined by any conventional process. Complex or large geometries may thus be formed by fabricating simple or smaller substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the seat 94 and seat components 94.

Once the plated layer 30 has been applied to the substrate 28, or substrate segments, additional features may be attached. Such features may include bosses, flanges, or inserts and may be attached by adhesive, riveting, and the like. A polymeric coating may also be applied to the components 96, once the plated layer 30 has been fully applied, to produce a light-weight, stiff, and strong polymeric appearing, non-conductive, seat components 96. This coating may be applied to the entire component 96 or to specific areas of the components 96, as desired, by any conventional process such as spray coating or dip coating. For example, areas of the components 96 where a plated layer 30 was not applied may also not receive a polymeric coating since the polymeric substrate 28 is already exposed.

From the foregoing it can be seen that a seat component may be formed from a plated polymer potentially providing decreased weight as compared to traditional materials. The plated polymer also allows the seat component to resist erosion, impact, and foreign-object damage effectively. Further, these qualities can be optimized in necessary areas without adding undue weight to the component. The materials required to form a plated polymeric seat component are also cheaper and more readily available than typical materials. As such, plated polymer seat components and the methods used to form such components can provide many added benefits over the traditional materials and methods found in the industry.

Aircraft Pontoon

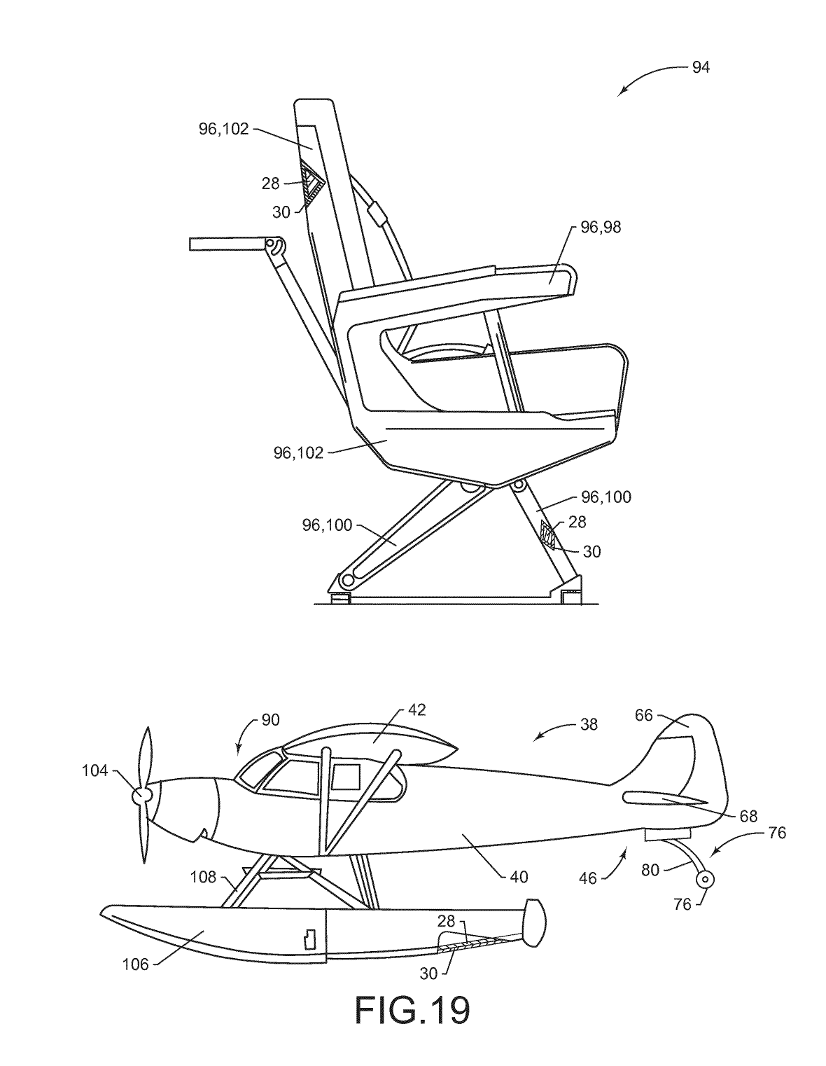

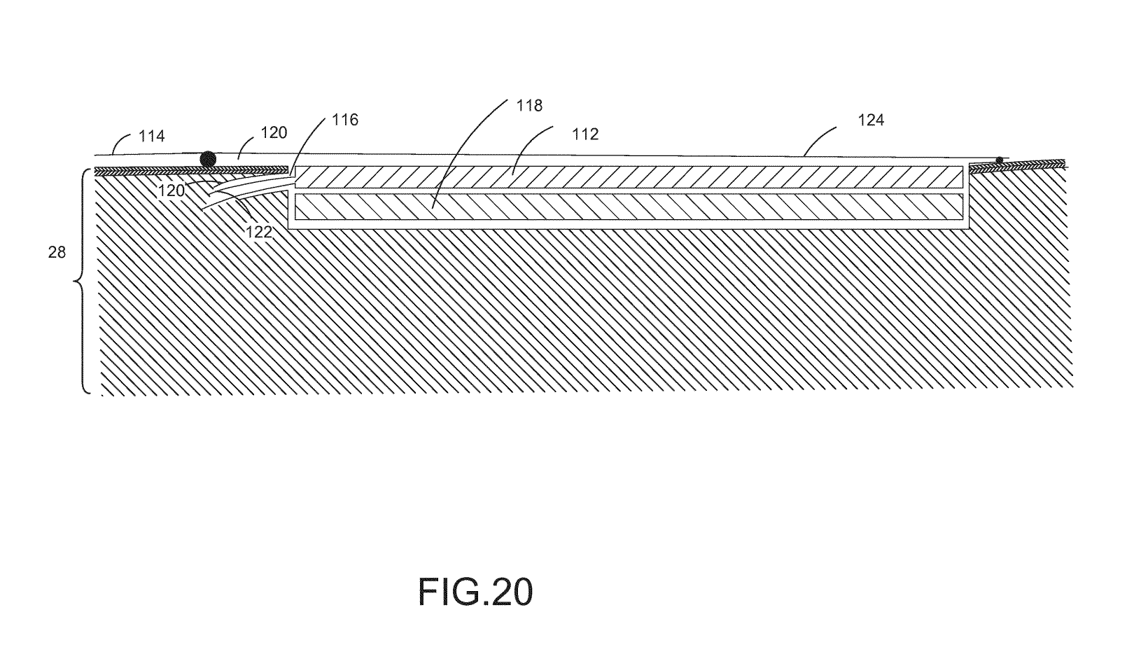

Some aircraft 38, such as the seaplane illustrated in FIG. 19, may include a fuselage 40, a source of lift (a pair of fixed wings 42), a source of thrust (a propeller engine 104 in this case), an empennage 46, and a pontoon 106. The pontoon 106 is attached to the aircraft 38 via a support 108, which is shown here as attaching to the fuselage 40. However, the support 108 may attach to other components of the aircraft 38 such as, but not limited to, the wings 42. The pontoon 106 must have a high strength and light weight to ensure that the pontoon 106 can survive landing, support the aircraft 38 once in the water, and reduce the impact the pontoon 106 has on the load-carrying capacity of the aircraft 38. Typically, the pontoon 106 is made from aluminum to achieve these requirements. However, plated polymers introduce new materials and construction methods that may be lighter and cheaper than typical materials and methods.

The pontoon 106 of the present disclosure may be formed of a polymeric substrate 28 and a plated layer 30. The substrate 28 may be fabricated into any suitable shape, such as the aerodynamic “boat-hull” shape of the pontoon 106 illustrated in FIG. 19 or the trapezoidal shape of the support 108 also illustrated in FIG. 19, by many methods including, but not limited to, injection-molding, compression-molding, additive manufacturing (including liquid bed, powder bed, and deposition processes), or composite-layup (including autoclave, compression, and liquid molding). The substrate 28 may be formed of one or more thermoplastic or thermoset materials. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass to provide additional strength to the substrate 28. The substrate 28 may be formed into any desired thickness, allowing great freedom in the construction of the pontoon 106.

After forming the substrate 28, some mounting features such as flanges, bosses, or the like may be bonded onto the substrate 28, using a suitable adhesive, to simplify the mold tooling. However, some features may alternatively be bonded to the pontoon 106 once the plated layer 30 has been applied.

The plated layer 30 may be applied in a number of metallic layers 32, as illustrated in FIG. 3, up to any desired thickness. Each of these metallic layers 32 may be applied by electroless plating, electroplating, or electroforming until the desired thickness is achieved. One exemplary plated layer 30 may have a thickness between about 0.001 inches to about 0.05 inches with an average thickness from about 0.004 inches to about 0.04 inches. This range of thicknesses may provide adequate resistance to erosion, impact, and foreign-object damage for the pontoon 106 to endure flight and landing in water, and may also allow the plated layer 30 to be finished more aggressively to meet tight tolerances or surface finish requirements. However, other thicknesses are also possible and the ranges presented herein are merely one exemplary embodiment of the plated layer 30 and should not be considered limiting.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures or loads on the plated polymeric structure by increasing interfacing bond strength or preventing the plated layer 30 from peeling away from the substrate 28. For example, friction between the pontoon 106 and the water may generate heat, and these stronger interfacing bonds between the plated layer 30 and substrate 28 may allow the plated polymer to resist this heat that may have otherwise damaged the pontoon 106.

The metallic layers 32 may also be selectively applied to desired areas of the substrate 28 to create a non-uniform thickness profile. This may be accomplished by masking portions of the substrate 28 as the metallic layers 32 are applied. The non-uniform thickness profile may also be achieved by tailored racking, including shields, thieves, conformal anodes, and the like. However formed, the non-uniform thickness profile may allow for optimization of properties of the components 96 such as, but not limited to, structural support and surface characteristics. By selectively applying the metallic layers 32 to areas of need these qualities may be optimized, while not adding additional weight to the pontoon 106. While particular pontoon configurations are described herein and illustrated in FIG. 19, other pontoon configurations are also possible. The illustrated pontoon 106 is intended to only be an exemplary embodiment of a plated polymeric pontoon and should not be considered limiting.

The pontoon 106 may also be constructed from multiple segments of substrate 28 that are each individually molded and then joined by any conventional process. Complex or large geometries may thus be formed by fabricating simple or smaller substrate segments and then joining the segments together. Such processes for joining the segments may include, but are not limited to, ultrasonic welding, laser welding, friction welding, friction-stir welding, traditional welding processes, adhesive, and miter joints with or without adhesive. These methods may be used before the plated layer 30 is applied as the plated layer 30 may be damaged by many of the above methods. However, by using transient liquid phase (TLP) bonding, the substrate 28 segments may be individually formed and plated and then joined together to form the pontoon 106.

Once the plated layer 30 has been applied to the substrate 28, or substrate segments, additional features may be attached. Such features may include bosses, flanges, or inserts and may be attached by adhesive, riveting, and the like. A polymeric coating may also be applied to the pontoon 106, once the plated layer 30 has been fully applied, to produce a light-weight, stiff, and strong polymeric appearing, non-conductive, pontoon 106. This coating may be applied to the entire pontoon 106 or to specific areas of the pontoon 106, as desired, by any conventional process such as spray coating or dip coating. For example, areas of the pontoon 106 where a plated layer 30 was not applied may also not receive a polymeric coating since the polymeric substrate 28 is already exposed.

Hereto, the pontoon 106 has been described as constructed solely from plated polymers. However, the pontoon 106 may also be a composite of plated polymers and other materials. This may take the form of plated polymeric components joined, bonded, attached, or otherwise connected to components made from other materials. For example, the pontoon 106 may be formed from the substrate 28 and plated layer 30, while the support 108 may be formed from a metallic material, such as aluminum for example. Other combinations of plated polymers and other materials are also possible, and this is merely one exemplary embodiment of a composite pontoon 106 and should not be considered limiting.

From the foregoing it can be seen that a pontoon may be formed from a plated polymer potentially providing decreased weight as compared to traditional materials. The plated polymer also potentially allows the pontoon to resist erosion, impact, and foreign-object damage effectively. Further, these qualities can be optimized in necessary areas without adding undue weight to the pontoon. The materials required to form a plated polymeric pontoon are also cheaper and more readily available than typical materials. As such, plated polymeric pontoon and the methods used to form such a pontoon can provide many added benefits over the traditional materials and methods found in the industry. Further, while the present disclosure has been directed to a pontoon for an aircraft, it is envisioned that materials and methods described herein may also be applied to other marine applications such as, but not limited to, canoes, marine buoys, and boat hulls.

Over-Plated Heating Element

Modern aircraft 38, such as the passenger plane illustrated in FIG. 4 for example, may include a fuselage 40, a source of lift (a pair of fixed wings 42), a source of thrust (gas turbine engines 44 in this case), an empennage 46, control surfaces 48, as well as many other components 110. Many of the aircraft components 110 may be adversely affected by ice buildup. For example, ice buildup on the gas turbine engine 44 may reduce engine efficiency and ice buildup on the control surface 48 may prevent the control surfaces 48 from responding to pilot commands or may alter their intended function(s). As such, heating elements 112 are typically employed at or near these ice-sensitive components to resist detrimental ice buildup. However, positioning of these heating elements 112 may be difficult. When the heating element 112 is positioned close to the location of ice buildup the heating element 112 may be difficult to incorporate in the component structure, may be damaged by environmental conditions, or may adversely affect the operation of the component 110. When the heating element 112 is instead positioned at a more accommodating position further from the ice buildup location it must rely on conductive heat transfer to heat the component and shed ice and may therefore need to be larger to generate and transfer enough heat to the ice buildup location to shed the ice. Plated polymeric components, formed from a polymeric substrate 28 and a metal plated layer 30, offer new positioning options for the heating element 112.

As can be seen in FIG. 20, the component 110 is formed from a polymeric substrate 28. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymeric material of the polymeric substrate 28 may be structurally reinforced with reinforcing materials which may include carbon, metal, or glass. This substrate 28 may be fabricated by many methods including, but not limited to, injection-molding, compression-molding, blow-molding, additive manufacturing (including liquid bed, powder bed, and deposition processes), or composite-layup (including autoclave, compression, and liquid molding). The substrate 28 may have already gone through a step of activation in preparation for plating and may have an outer layer 114 of copper or other suitable conductive materials, such as silver. The substrate 28 defines a pocket 116 of sufficient size to accommodate at least the heating element 112. An insulating layer 118 may also be positioned within the pocket 116 to limit heat transfer into the substrate 28 and may take the form of a simple layer, as illustrated in FIG. 20, or a pocket covering between two and five sides of the heating element 112. A side of the heating element 112 nearest the surface of the substrate 28 is left bare of insulation to allow heat from the heating element 112 to transfer to the plated layer 30 and assist in shedding ice.

A passageway 120 may be formed in the substrate 28 to accommodate wire leads 122 from the heating element 112. The passageway 120 may be produced during forming of the substrate 28 or machined once the substrate 28 has been fabricated. This passageway 120 may assist in protecting the wire leads 122 from environmental conditions. Once the heating element 112 and wire leads 122 are positioned within the pocket 116 and passageway 120 a covering layer 124, typically formed of the same material as the outer layer 114, may then be positioned over the heating element 112 completely covering the pocket 116 and attached to the substrate 28. This attachment may be accomplished by many methods such as tack welding or adhesive, for example.

Once the covering layer 124 is secure, the plated layer 30 may then be applied, in a number of metallic layers 32, if desired, up to any desired thickness. Each of these metallic layers 32 may be applied by electroless plating, electroplating, or electroforming until the desired thickness is achieved. The plating material may be any metallic material, but one exemplary embodiment of the plated layer 30 is formed from nickel. While plating, exposed wire leads 122 must be masked to prevent undesirable plating buildup. Nodules may also form near or on the covering layer 124, for example by building up on tack weld beads. These nodules may be machined off, if necessary, by any conventional means such as, but not limited to, grinding.

While a typical bond between the plated layer 30 and substrate 28 may be acceptable for many applications, a stronger interfacing bond may also be formed if desired. Such a stronger bond may be formed by many methods such as, but not limited to, sub-surface interlocking, interlocked plating, plating adhesion promoting, and plated polymer venting. These methods of bonding the plated layer 30 and substrate 28 may reduce the effects of high temperatures on the plated polymeric structure by increasing interfacing bond strength or preventing the plated layer 30 from peeling away from the substrate 28. For example, an un-insulated heating element 112 may generate enough heat that traditional plated polymers may be damaged; these stronger interfacing bonds between the plated layer 30 and substrate 28 may allow the plated polymeric structure to resist this thermal damage.

From the foregoing it can be seen that an over-plated heating element provides a robust and efficient method of increasing surface temperatures directly at the desired area(s). The plated layer also protects the heating element from the environment while efficiently distributing heat form the heating element to the desired location(s). Wires for the heating elements may also be sufficiently protected from the environment by routing the wires through the substrate. The substrate and plating materials are also low cost and readily available, allowing for cheaper construction and maintenance.

What is claimed is:

1. A component for an aircraft, the component comprising:
a polymeric substrate having an outer surface; and
a first metal deposited on the outer surface creating a plated layer.

2. The component of claim 1 wherein the polymeric substrate is formed into one of an unmanned aerial vehicle, a wing, a control surface, an empennage, a foreplane, a fuselage, aircraft landing gear, an aircraft instrumentation panel, an aircraft seat, a propeller, a helicopter tail rotor blade, a helicopter primary rotor blade, and an aircraft pontoon.

3. The component of claim 2 wherein the formed into one of is performed with a process selected from the group consisting of injection-molding, compression-molding, blow-molding, liquid bed additive manufacturing, powder bed additive manufacturing, deposition process additive manufacturing, autoclave composite-layup, compression composite layup, liquid molding composite layup and combinations thereof.

4. The component of claim 1 wherein the polymeric substrate is a thermoplastic material selected from the group consisting of polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof.

5. The component of claim 1 wherein the polymeric substrate is a thermoset material selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, thermoset silicones and combinations thereof.

6. The component of claim 1 wherein the polymeric substrate is strengthened with reinforcing materials selected from the group consisting of carbon, metal, glass and combinations thereof.

7. The component of claim 1 wherein the plated layer has a windward surface and a leeward surface and having a thicker plated layer on the windward surface than the leeward surface.

8. The component of claim 1 having an additional metal disposed onto the first metal.

9. The component of claim 1 further including a mounting feature bonded onto the polymeric substrate selected from the group consisting of flanges, bosses and combinations thereof.

10. The component of claim 1 further including a mounting feature bonded onto the plating layer selected from the group consisting of flanges, bosses and combinations thereof.

11. A method for fabricating a component for an aircraft, the method comprising:
forming a polymeric substrate into a desired shape having an outer surface; and
plating a first metal onto the outer surface to form a plated layer.

12. The method of claim 11 wherein the desired shape is selected from the group consisting of an unmanned aerial vehicle, a wing, a control surface, an empennage, a foreplane, a fuselage, aircraft landing gear, an aircraft instrumentation panel, a propeller, a helicopter tail rotor blade, a helicopter primary rotor blade, an aircraft seat and an aircraft pontoon.

13. The method of claim 11 wherein the forming a polymeric substrate into a desired shape is performed with a process selected from the group consisting of injection-molding, compression-molding, blow-molding, liquid bed additive manufacturing, powder bed additive manufacturing, deposition process additive manufacturing, autoclave composite-layup, compression composite layup, liquid molding composite layup and combinations thereof.

14. The method of claim 11 wherein the polymeric substrate is a thermoplastic material selected from the group consisting of polyetherimide (PEI), thermoplastic polyimide, polyether ether ketone (PEEK), polyether ketone ketone (PEKK), polysulfone, polyamide, polyphenylsulfide, polyester, polyimide, nylon, and combinations thereof.

15. The method of claim 11 wherein the polymeric substrate is a thermoset material selected from the group consisting of condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof.

16. The method of claim 11 further including strengthening the polymeric substrate with a reinforcing material selected from the group consisting of carbon, metal, glass and combinations thereof.

17. The method of claim 11 wherein the plated layer has a windward surface and a leeward surface and wherein plating creates a thicker plated layer on the windward surface than the leeward surface.

18. The method of claim 11 further including bonding a mounting feature onto the polymeric substrate before plating and wherein the mounting feature is selected from the group consisting of flanges, bosses and combinations thereof.

19. The method of claim 11 further including bonding a mounting feature onto the plated layer and wherein the mounting feature is selected from the group consisting of flanges, bosses and combinations thereof.

20. An over-plated heating device for shedding ice from an aircraft, comprising:
a polymeric substrate having a pocket to receive a heating element and having an outer surface;
a first metal deposited on the outer surface creating a plated layer;
a heating element positioned in the pocket of the polymeric substrate;
an insulating layer positioned between the polymeric substrate and the heating element; and
a covering layer deposited onto the heating element and plated layer.
